(19) United States
(12) Patent Application Publication
(10) Pub. No.: US 2012/0110894 A1
(43) Pub. Date: May 10, 2012

(54) Bed Bug Monitor Device for Vertical Surfaces

(75) Inventors: Bruce C. Black, Yardley, PA (US); Shreya Sheth, Lawrenceville, NJ (US); Linda Varanyak, Mercerville, NJ (US); Keith F. Woodruff, Mountainside, NJ (US); Michael J. Engram, Newtown, PA (US); Amelie H. Riendl, Moorestown, NJ (US); Joseph Pruitt, Athens, GA (US); Jerry V. Foster, Lawrenceville, GA (US); Donald A. Muntner, Lawrenceville, GA (US); Erica Knight, Chamblee, GA (US); James Noah McNeely, Suwanee, GA (US); David Nelson Jackson, Grayson, GA (US)

(73) Assignee: FMC CORPORATION, Philadelphia, PA (US)

(21) Appl. No.: 13/253,160

(22) Filed: Oct. 5, 2011

Related U.S. Application Data
(60) Provisional application No. 61/411,016, filed on Nov. 8, 2010.

(51) Int. Cl. A01M 1/10; A01M 1/02

(52) U.S. Cl. 43/123; 43/131

(57) ABSTRACT

A bed bug monitor and/or capture device includes a housing defining a substantially enclosed interior space and a deadfall trap; a harborage element mounted adjacent the deadfall trap that defines at least one pathway through which bed bugs can travel; at least one bed bug attractant element positioned within the interior space of the housing; and at least one opening defined in at least one wall of the housing at a location either on or adjacent the deadfall trap and/or the harborage element, wherein fumes emanating from the bed bug attractant element can escape through the at least one opening to a location outside of the device in order to lure bed bugs toward the deadfall trap and the harborage element.

### CROSS-REFERENCE TO RELATED APPLICATIONS

This application claims the benefit of U.S. Provisional Application No. 61/411,016 filed Nov. 8, 2010.

### FIELD OF THE INVENTION

The present invention relates to a bed bug monitor and/or capture device.

### BACKGROUND OF THE INVENTION

Bed bugs are small nocturnal insects of the family Cimicidae that feed off the blood of humans and other warm blooded hosts. Bed bugs exhibit cryptic behavior, which makes their detection and control difficult and time consuming. This is particularly true for the common bed bug, Cimex lectularius, which has become well adapted to human environments. Other species of bed bugs, for example, Cimex hemipterus, are nuisances to people and/or animals as well.

While bed bugs have been controlled in many areas, such as the United States, the increase in international travel has contributed to a resurgence of these pests in recent years. There are many aspects of bed bugs which make it difficult to eradicate them once they have established a presence in a location. Accordingly, there is a need for effective traps to determine the presence of bed bugs before they become entrenched.

Adult bed bugs are about 6 millimeters long, 5 to 6 millimeters wide, and are reddish brown with oval, flattened bodies. The immature nymphs are similar in appearance to the adults, but are smaller and lighter in color. Bed bugs do not fly, but can move quickly over surfaces. Female bed bugs lay their eggs in secluded areas and can deposit up to five eggs per day, and as many as 500 during a lifetime. The bed bug eggs are very small, about the size of a dust spec. When first laid, the eggs are sticky causing them to adhere to surfaces.

Bed bugs can go for long periods of time without feeding. Nymphs can survive for weeks without feeding, while adults can survive for months. Consequently, infestations cannot be eliminated simply by leaving a location unoccupied for brief periods of time.

While bed bugs are active during the nighttime, during daylight they tend to hide in tiny crevices or cracks. Bed bugs may therefore find easy hiding places in beds, bed frames, furniture, along baseboards, in carpeting and countless other places. Bed bugs tend to aggregate but do not build nests like some other insects.

Bed bugs obtain their sustenance by drawing blood through elongated mouth parts. They may feed on a human for 3 to 10 minutes, although the person is not likely to feel the bite. After the bite, the victim often experiences an itchy welt or a delayed hypersensitivity reaction resulting in a swelling in the area of the bite. However, some people do not have any reaction or only a very small reaction to a bed bug bite. Bed bug bites have symptoms that are similar to other pests, such as mosquitoes and ticks. It is not possible to determine whether a bite is from a bed bug or another type of pest; and bites may be misdiagnosed as hives or a skin rash. Consequently, bed bug infestations may frequently go on for long periods before they are recognized.

Bed bug infestations originate by a bed bug being carried into a new area. Bed bugs are able to cling to possessions and hide in small spaces, such that they may be transported in a traveler's belongings. As a result, buildings where the turnover of occupants is high, such as hotels, motels, inns, barracks, cruise ships, shelters, nursing homes, camp dwellings, dormitories, condominiums and apartments, are especially vulnerable to bed bug infestations.

Because of all the features of bed bugs described herein, bed bugs are both difficult to detect and eradicate. Professional pest removal specialists and pesticides are needed. It is necessary to remove all clutter and unnecessary objects from a room, remove bed bugs and eggs as much as possible through vacuuming, and apply pesticides to likely hiding areas. This type of treatment for eradication can be disruptive to a business such as a hotel. As a result, it is desirable to detect bed bug infestations as early as possible in order to begin eradication procedures.

The tiny, mobile and secretive behavior of bed bugs makes it nearly impossible to prevent and control an infestation unless they are quickly discovered and treated. Bed bugs have been found to move through holes in walls, ceilings and floors into adjacent rooms. Devices and methods for the early detection of bed bugs are especially needed in the hospitality industries.

While several attempts have been made to devise bed bug monitoring and/or capture devices in the past, these devices have, in general, not proven to be commercially effective. The present inventors have studied many aspects of bed bug behavior, and believe that one factor in the failure of such devices to desirably perform is the lack of an effective trapping mechanism.

Thus, it has been observed by the present inventors that bed bugs, unlike many other insect pests, are resistant to many types of sticky traps, having the ability to cross traps that would snare other insects, particularly where a heating element is not employed. Consequently, bed bug monitors that rely upon luring bed bugs to sticky traps may not be effective as the bed bugs may simply walk across the trap surface and eventually exit the device.

Further, it has been previously observed that bed bugs are extremely sensitive to the roughness of the surfaces on which they are placed. Bed bugs tend to avoid crossing smooth surfaces, rendering current traps which require such a traversal before they are trapped ineffective. Indeed, it has been unexpectedly found that traps having a textured surface which are effective to control other insect species are (when modified to contain a bed bug attractant) ineffective to control bed bugs as their surface is apparently too smooth for the bed bugs despite such outwardly rough appearance.

The present invention overcomes the above-identified problems by providing novel bed bug monitors and/or capture devices.

### SUMMARY OF THE INVENTION

In one aspect, the present invention relates to a bed bug monitor and/or capture device that can be mounted on a vertical surface comprising: (a) a bed bug attractant element; and (b) a harborage element comprising at least one pathway comprising: (i) a base segment; (ii) an interior segment; and (iii) a top segment.

In another aspect, the invention is directed to a bed bug monitor and/or capture device comprising:

a) a bed bug attractant element comprising
i) an aldehyde;
ii) an organic acid;
iii) carbon dioxide; and

b) a harborage element comprising at least one pathway comprising:
i) a base segment;
ii) an interior segment; and
iii) a top segment.

The monitor and/or capture device can further comprise a deadfall trap.

In yet another aspect, the invention is directed to a bed bug monitor and/or capture device comprising a deadfall trap having one or more openings through a surface thereof. In a further aspect, the bed bug monitor and/or capture device further comprises a harborage mounted adjacent to the deadfall trap. In a still further aspect, the one or more openings are provided through a bottom surface of the deadfall trap.

In yet another aspect, the invention is directed to a bed bug monitor and/or capture device comprising a housing defining a substantially enclosed interior space; at least one bed bug attractant element positioned within the interior space of the housing; a harborage element that is either defined on the housing or positioned on the housing, said harborage element defining at least one pathway through which bed bugs can travel; and at least one opening defined in at least one wall of the housing at a location adjacent to the harborage element, wherein fumes emanating from the bed bug attractant element can escape through at least one opening to a location outside of the device in order to attract bed bugs toward said harborage element.

In still another aspect, the invention is directed to a bed bug monitor and/or capture device comprising a housing defining a substantially enclosed interior space and a deadfall trap; at least one bed bug attractant element positioned within the interior space of the housing; and at least one opening defined in at least one wall of the housing at a location either on or adjacent the deadfall trap, wherein fumes emanating from the bed bug attractant element can escape through at least one opening to a location outside of the device in order to lure bed bugs toward said deadfall trap.

In still another aspect, the invention is directed to a kit for monitoring and/or capturing bed bugs comprising a housing defining a substantially enclosed interior space and a plurality of apertures defined in one or more walls of the housing that provide one or more fume passageways from the interior space to one or more locations outside of the housing to attract bed bugs toward the housing; a source of carbon dioxide that is configured to be positioned within the interior space of the housing at a location that is adjacent at least one of the plurality of apertures of the housing; a source of organic acid that is configured to be positioned within the interior space of the housing at a location that is adjacent at least one of the plurality of apertures of the housing; and a source of aldehyde that is configured to be positioned within the interior space of the housing at a location that is adjacent at least one of the plurality of apertures of the housing.

In yet another aspect, the invention is directed to a carbon dioxide cartridge assembly for a bed bug monitor and/or capture device comprising a housing including an interior space having a plurality of compartments, and at least one opening defined in a wall of the housing to permit air to enter the interior space and the escapement of carbon dioxide from within the interior space to a location outside of the housing to attract bed bugs towards the bed bug monitor and/or capture device. In a first embodiment the carbon dioxide cartridge assembly can have two compartments and include a first chemical composition contained within the first compartment and a second chemical composition contained within the second compartment. The cartridge assembly can further include one or more removable seals covering the first and second compartments to prevent inadvertent mixing of the chemical content of the first and second compartments, wherein upon removing the seals, the chemical contents of the compartments can be mixed together with any moisture in air contained in the interior space to yield carbon dioxide. In a second embodiment the carbon dioxide cartridge assembly can include a third chemical composition contained within a third compartment. In this embodiment one or more removable seals can cover the first, second and third compartments to prevent inadvertent mixing of the chemical contents of the compartments, wherein upon removing the seals, the chemical contents of the plurality of compartments can be mixed together to yield carbon dioxide.

In another aspect, the invention is directed to an ampoule assembly for a bed bug monitor and/or capture device comprising a housing including two discrete vials; a first chemical composition contained within one vial of the housing; a second chemical composition contained within the other vial of the housing; and one or more seals covering the vials to prevent inadvertent escapement of the chemical contents of the vials.

### BRIEF DESCRIPTION OF THE DRAWINGS

FIG. 1 is a perspective view of a bed bug monitor and/or capture device according to a first exemplary embodiment of the invention.

FIG. 2 is a side view of a bed bug monitoring and/or capture device of this embodiment of the invention.

FIG. 3 is a bottom view of a bed bug monitoring and/or capture device of this embodiment of the invention.

FIG. 4A is a top view, FIG. 4B is a front view and FIG. 4C is a cross sectional view (taken along section A-A of FIG. 4B) of a second embodiment of a bed bug monitor and/or capture device of this invention.

FIG. 5 is a perspective view of a bed bug monitor and/or capture device according to the second embodiment of the invention.

FIG. 6 is a cross sectional view of a holder containing bed bug attractants according to the second embodiment of the invention.

FIG. 7 is a perspective view of a bed bug monitor device according to the second embodiment of the invention.

FIG. 8 is a perspective view of a top segment for generation and distribution of carbon dioxide for use in a bed bug monitor device according to the second embodiment of the invention.

FIG. 9A is a top perspective, FIG. 9B is a top view and FIG. 9C is a back view of a third embodiment of a bed bug monitor and/or capture device of this invention.

FIG. 10A is a top perspective and FIG. 10B is a top view of a deadfall trap according to the third embodiment of the bed bug monitor and/or capture device of this invention.

FIG. 11A is a top perspective view, FIG. 11B is a bottom perspective view, FIG. 11C is a left side view, FIG. 11D is a front view, FIG. 11E is a right side view and FIG. 11F is a back view of a holder insert of the third embodiment of a bed bug monitor and/or capture device of this invention.

FIG. 12A is a top perspective view, FIG. 12B is a bottom perspective view, FIG. 12 C is a top view and FIG. 12D is a left side view of an ampoule holder of the third embodiment of the bed bug monitor and/or capture device of this invention.

FIG. 13 is a top perspective view of an ampoule of the third embodiment of a bed bug monitor and/or capture device of this invention.

FIG. 14A is a front view and FIG. 14B is a top perspective view of the rear of the carbon dioxide generating cartridge of the third embodiment of the bed bug monitor and/or capture device of this invention, wherein the cartridge is shown pivoted to an open position.

FIG. 15 is a perspective view of a harborage of the third embodiment of the bed bug monitor and/or capture device of this invention.

FIG. 16A is a top perspective view of a partial assembly of the third embodiment of the bed bug monitor and/or capture device of the invention where the holder insert, deadfall trap, ampoule holder and harborage are shown assembled while the carbon dioxide cartridge and ampoule are shown exploded. FIG. 16B is a top perspective view of the partial assembly of the third embodiment of the bed bug monitor and/or capture device of FIG. 16A shown completely assembled.

FIG. 17A is a top perspective view and FIG. 17B is a bottom view of the holder of the third embodiment of the bed bug monitor and/or capture device of this invention.

### DETAILED DESCRIPTION OF THE INVENTION

In one aspect the present invention relates to a bed bug monitor and/or capture device that can be mounted on a vertical surface comprising: (a) a bed bug attractant element; and (b) a harborage element comprising at least one pathway comprising: (i) a base segment; (ii) an interior segment; and (iii) a top segment. The monitor and/or capture device can further comprise a deadfall trap.

The device of this invention may comprise any bed bug attractant which is effective to lure bed bugs to the device such that they enter into the pathway of the harborage or into the deadfall trap. Attractants which can be employed include carbon dioxide, heat, pheromones, human sweat components and the like. Mixtures of one or more attractants can also be employed.

One attractant which is particularly preferred is a composition comprising an unsaturated aldehyde component (pheromone component) and an organic acid component (kairomone component). It is preferred that the unsaturated aldehyde component be comprised of one or more aldehydes selected from the group consisting of trans-2-hexen-1-al (Hexenal) and trans-2-octen-1-al (Octenal). It is preferred that the organic acid component be butyric acid. When the aldehyde component is comprised of both Hexenal and Octenal, it is preferred that the aldehydes be present in a ratio of from about 1:5 and about 5:1 of Hexenal to Octenal, more preferably in a ratio of between about 3:1 and about 1:3. In order to be most attractive to bed bugs, the optimal concentration of the Hexenal and Octenal mixture to be released is from about 300 ng/hr to about 500 ng/hour, and the optimal concentration of butyric acid to be released is between about 100 ng/hr and about 300 ng/hr. Mixing butyric acid with Hexenal and Octenal forms an unstable composition and it is necessary to separate the aldehyde component from the acid component. In order for the separate components of the attractant composition to be released at the proper rates, each component can be incorporated into a formulation which can be in gel form, a solid form, dissolved in a polar solvent such as water, dissolved in an organic solvent, for example a C₈-C₁₂ alkane, and preferably a C₉-C₁₀ alkane, encapsulated, or impregnated into other materials. In one aspect of the invention suitable attractants comprise Octenal dissolved in nonane at a concentration range of about 2000 to 3000 ppm Octenal, preferably from about 2500 to 2800 ppm Octenal, and more preferably from about 2700 to 2750 ppm Octenal. A second suitable attractant that can be used in conjunction with the Octenal is butyric acid dissolved in nonane at a concentration range of about 200 to 2000 ppm butyric acid, and preferably from about 240 to 400 ppm butyric acid.

Each component can be incorporated into an absorbent material, for example, but not limited to, cotton batting, fiberised cellulose wood pulp, synthetic batting, polyester batting, felt, bonded carded webs, very high density polyethylene sponge and high loft spunbond materials. In order to regulate diffusion, a semi-permeable membrane can be used to encase the absorbent materials. The attractant components can also be dispensed from containers with either a semi-permeable top or a sealed top containing one or more holes to allow diffusion into the surrounding atmosphere. For example, the top can be pierced or punctured at the point of use to allow diffusion into the surrounding atmosphere. Suitable tops include, for example, metal foils (e.g., aluminum foil). The metal foil top can be sealed to an open top of a suitable attractant container, such as a polymer vial or ampoule (e.g., PETG vial or ampoule).

An alternative preferred embodiment involves the attractant Octenal or Hexenal; with or without the use of butyric acid as a co-attractant.

Another preferred embodiment involves the attractant Octenal or Hexenal; with or without the use of butyric acid as a co-attractant and carbon dioxide.

Carbon dioxide can be dispensed by a number of means such as from a pressurized container having a regulating release valve, sublimation of dry ice, or generated by a chemical reaction.

When the attractant comprises a chemical attractant which is slightly heavier than air and is not under compression, such as pheromones, organic acids or other attractants such as carbon dioxide (including the mixed aldehyde/organic acid mixture described above), the device can be configured such that the bed bugs are lured into the pathway of the harborage element and induced to stay in the harborage element by locating the attractant element above the harborage element, allowing the attractant to flow downward through and around the harborage element by gravitational pull.

In another embodiment of the present invention, the device can be configured such that the bed bugs are lured into the pathway of the harborage element by locating the attractant element next to or below the harborage element and allowing the attractant to vaporize and surround the harborage and/or enter into a deadfall trap located next to the harborage and flow into the harborage element. The deadfall trap can be provided with one or more openings through a surface thereof to allow the attractant to flow into the deadfall trap. The one or more openings can be located at a bottom surface, a side surface or side surfaces, or a combination of bottom surface and side surface(s).

In one embodiment the harborage element can be comprised of three portions: (i) a base segment, such base segment being adapted to be placed flush with the vertical surface against which such device is to be placed; (ii) an interior segment which defines at least one entrance through which bed bugs attracted to the device can enter; and (iii) a top segment.

In one aspect of the present invention the base and top segment is comprised of a material that is strong enough to provide support for the interior segment, so that the harborage element will not bend easily. Suitable materials for the base and top segments include cardboard, chipboard, wood, plastic and the like. The inner surface of the base segment is preferably comprised of a material that provides a traversable surface for bed bugs, such that the average surface roughness of such surface is at least about 2.5 micrometers (roughness can be measured using a Mahr Pocket Surf® portable roughness gage). The interior segment provides at least one entrance through which bed bugs can enter comprising one or more protuberances which depend outward from the inner surface of such base segment. Such one or more protuberances define one or more channels which are of sufficient dimensions to permit a bed bug to crawl therein. Preferably, such protuberances are spaced to form channel widths of between about 2 mm and about 10 mm. The protuberances are preferably designed such that bottom portion of the channels formed thereby are concave in cross section. The protuberances should be of sufficient height such that bed bugs can crawl through the channels formed thereby. Another suitable interior segment material is fluted cardboard. The harborage element can be fastened together in many different ways and should be easily opened in order to inspect the interior segment for the presence of bed bugs. Methods of fastening the harborage element together include gluing the interior segment to the inner surfaces of the top segment and bottom segment, stapling the element together or taping the element together. The harborage element can be hinged in such a fashion that the top segment locks onto the bottom segment and can be opened by swinging up, down or sideways, thus exposing the interior segment.

In another aspect of the present invention the base of the harborage is a housing that can be placed flush with the vertical surface against which such device is to be placed and contains an insert comprising a carbon dioxide generating cartridge, pheromone and kairomone components, and a deadfall trap. The harborage can comprise an interior segment which defines at least one entrance through which bed bugs attracted to the device can enter.

It is preferred that the deadfall portion and the harborage portion of the device be dark in color, for example black, brown, red, dark red, reddish-brown, dark gray, navy blue, dark blue, deep violet and the like as bed bugs tend to choose to move towards darker colors rather than lighter colors. In general, colors darker than a photographic Gray card are preferred. The remaining visible portions of the device can be dark in color also, but more preferred lighter colors, for example, white, off-white or cream.

The present invention may be better understood by reference to the attached Figures which are intended to be demonstrative of certain embodiments, but are not intended to be limiting of the scope of the invention in any manner.

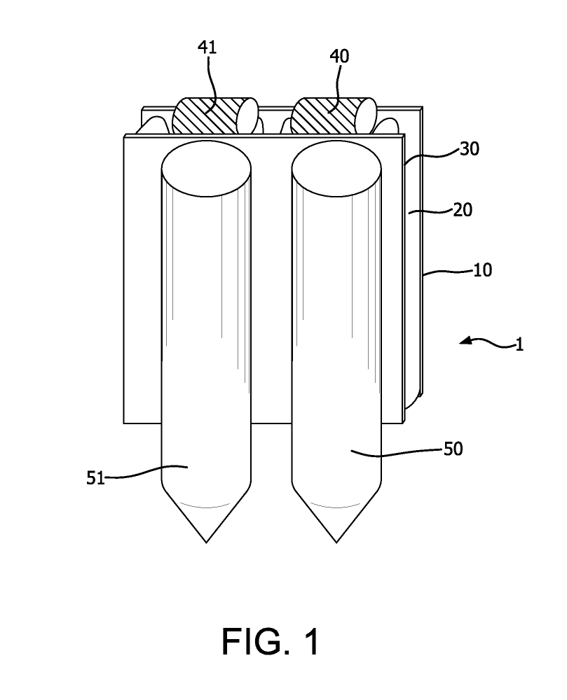

FIG. 1 is a perspective view of a first embodiment of the monitor and/or capture device 1 of this invention. In this embodiment, the harborage element is defined by (i) a base segment 30, such base segment being adapted to be placed flush with the vertical surface against which such device is to be placed; (ii) an interior segment 20, which defines at least one entrance through which bed bugs attracted to the device can enter; and (iii) an optional top segment 10. In an aspect of the invention, optional top segment 10 is a clear material to allow for easy visual inspection of the interior segment 20. In this embodiment the interior segment is comprised of fluted cardboard. Sealed containers 40 and 41 contain the aldehyde and acid attractants for dispensing and can be affixed to the device by gluing, taping or other means. Containers 50 and 51 are at least partially open at the top for dispensing generated carbon dioxide and can be affixed to the device by gluing, taping or other means.

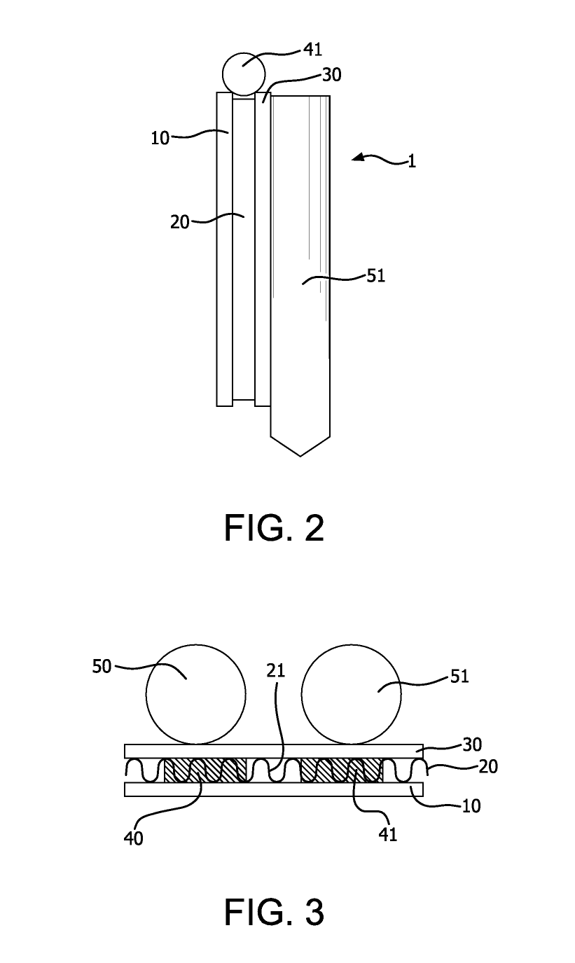

FIG. 2 is a side view of a first embodiment of a bed bug monitor and/or capture device of this invention.

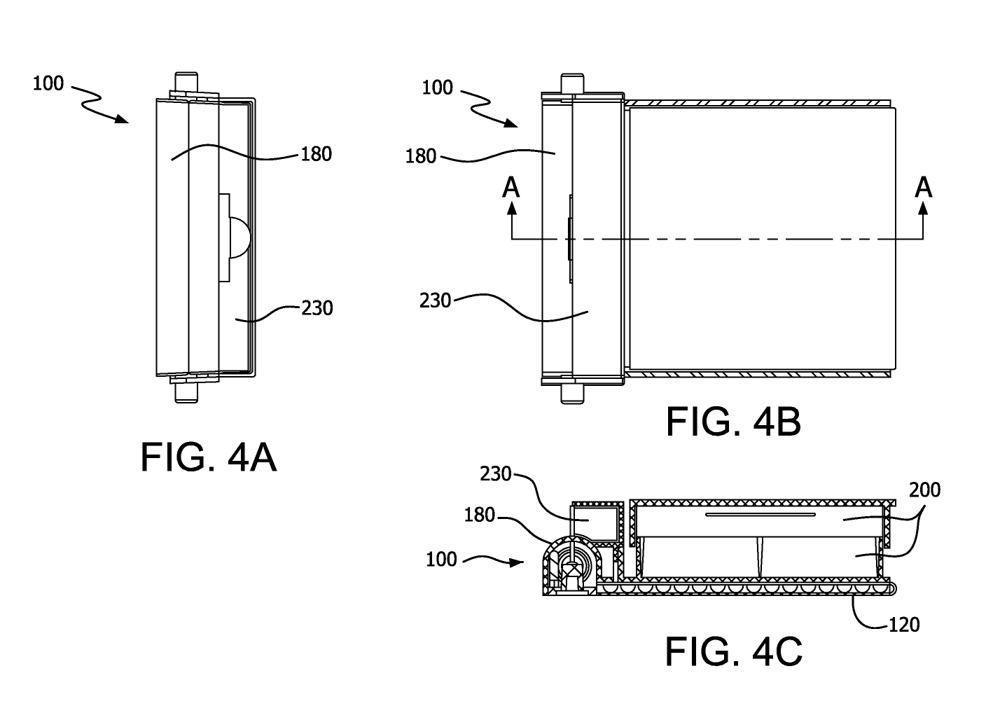

FIG. 3 is a bottom view of a first embodiment of a bed bug monitor and/or capture device of this invention. The interior segment 20, which defines at least one entrance 21, through which bed bugs attracted to the device can enter, is defined by fluted cardboard. Although the flutes are preferably situated vertically, or substantially vertically, the flutes can be, for example, situated at various angles, or even horizontally.

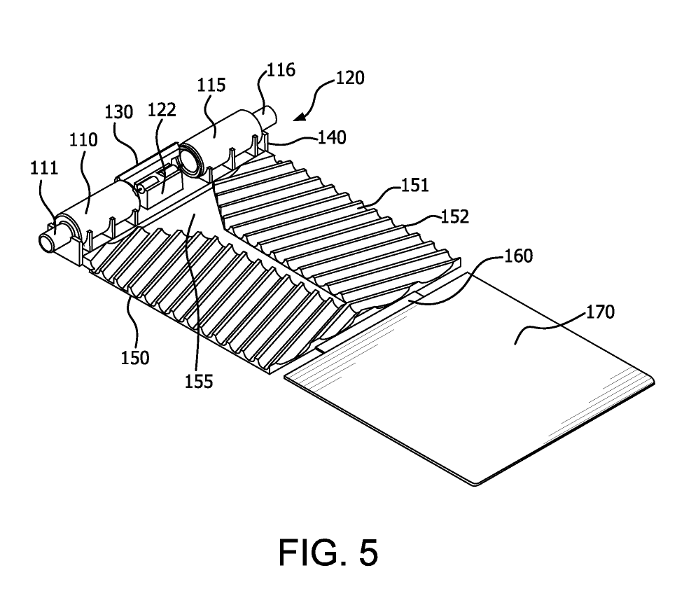

A further embodiment will be described with reference to FIGS. 4 through 8.

FIG. 4A is a top view, FIG. 4B is a front view and FIG. 4C is a cross sectional view (section A-A) of a second embodiment of a bed bug monitor and/or capture device of this invention 100. This device is composed of bottom member 120, optional protective cover 180, carbon dioxide generator cover housing 200 and optional deadfall trap 230.

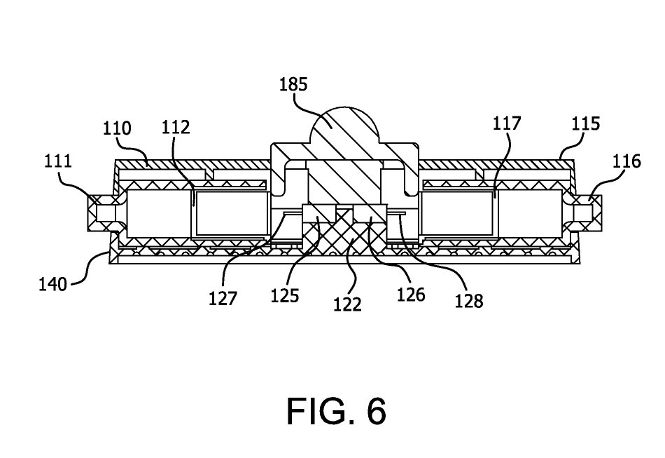

FIG. 5 is a perspective view of the bottom member 120 of the second embodiment of a bed bug monitoring and/or capture device of this invention. In this embodiment, the bottom member is the harborage and is defined by (i) a base segment 150, such base segment being adapted to be placed flush with the vertical surface against which such device is to be placed; (ii) an interior segment 151, which defines at least one entrance through which bed bugs attracted to the device can enter; and (iii) optional top segment 170. The interior segment 151 provides at least one entrance through which bed bugs can enter comprising one or more protuberances 152 which depend outward from the inner surface of the base segment 150. Such one or more protuberances define one or more channels which are of sufficient dimensions to permit a bed bug to crawl therein. Preferably, such protuberances are spaced to form channel widths of between about 2 mm and about 10 mm. The protuberances are preferably designed such that the bottom portion of the channels formed thereby are concave in cross section. The protuberances should be of sufficient height such that bed bugs can crawl through the channels formed thereby. The surface of the protuberances is preferably comprised of a material that provides a traversable surface for bed bugs, such that the average surface roughness of the surface is at least about 2.5 micrometers. The protuberances are preferably angled from the center of the base downward towards the outside of the base. However, any suitable arrangement can be used. The optional top segment 170 sits on top of the protuberances and is attached to the base segment 150 with a hinge 160. The base segment has one or more channels which direct bed bug attractants through the harborage area 155. The base segment has a holder 140 at the top of the protuberances.

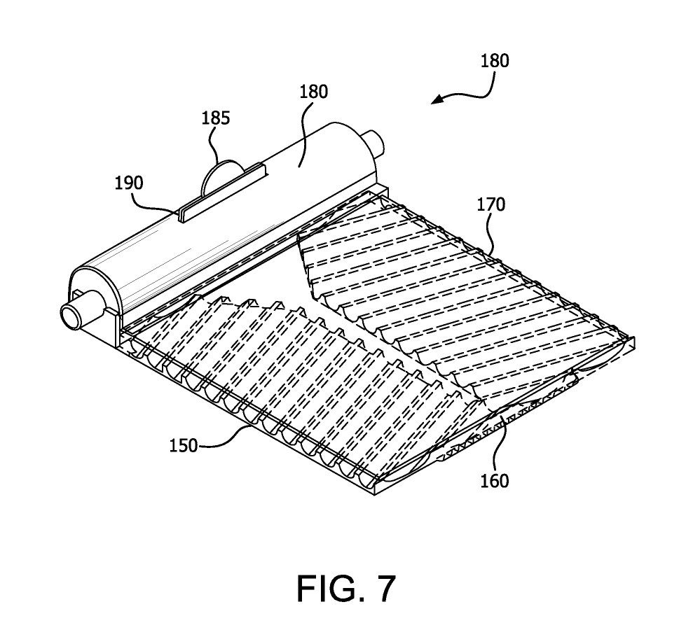

FIG. 6 is a cross sectional view of holder 140. The holder 140 has two cylindrical tubes 110 and 115 which position sealed containers 112 and 117 containing chemical attractants, such as aldehyde and acid. For dispensing the chemical attractants from the sealed containers, buttons 111 and 116 are pushed inward driving the sealed containers toward and into pins 127 and 128 mounted in holders 125 and 126, creating a desired diameter hole in the seal of the containers. Pin holders 125 and 126 are held in place by mounting member 122. The punctured containers are pushed away from the pins by an elastomeric material 130 (shown in FIG. 5) positioned above holders 125 and 126, allowing the chemical attractants to flow into channels 155. The base segment 150 is preferably made of plastic and is preferably dark in color. The top segment is preferably made of plastic and is clear in order to examine the protuberances.

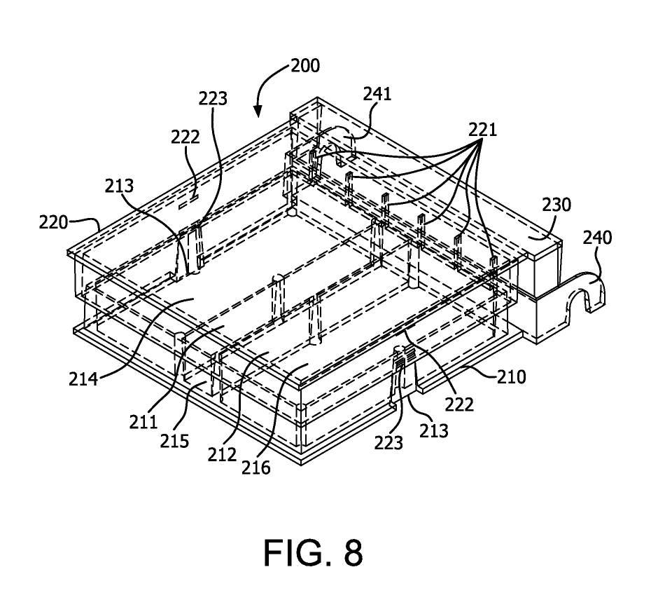

FIG. 7 is a perspective view of the bottom member 120 of the second embodiment of a bed bug monitor and/or capture device of this invention showing the optional top segment 170 in a closed position covering the bottom segment 150 and resting upon the protuberances. A protective plastic cover 180 fits over holder 140. A removable tab 185 made of plastic fits through slot 190 and prevents buttons 111 and 116 from being pushed inward until the tab 185 is removed.

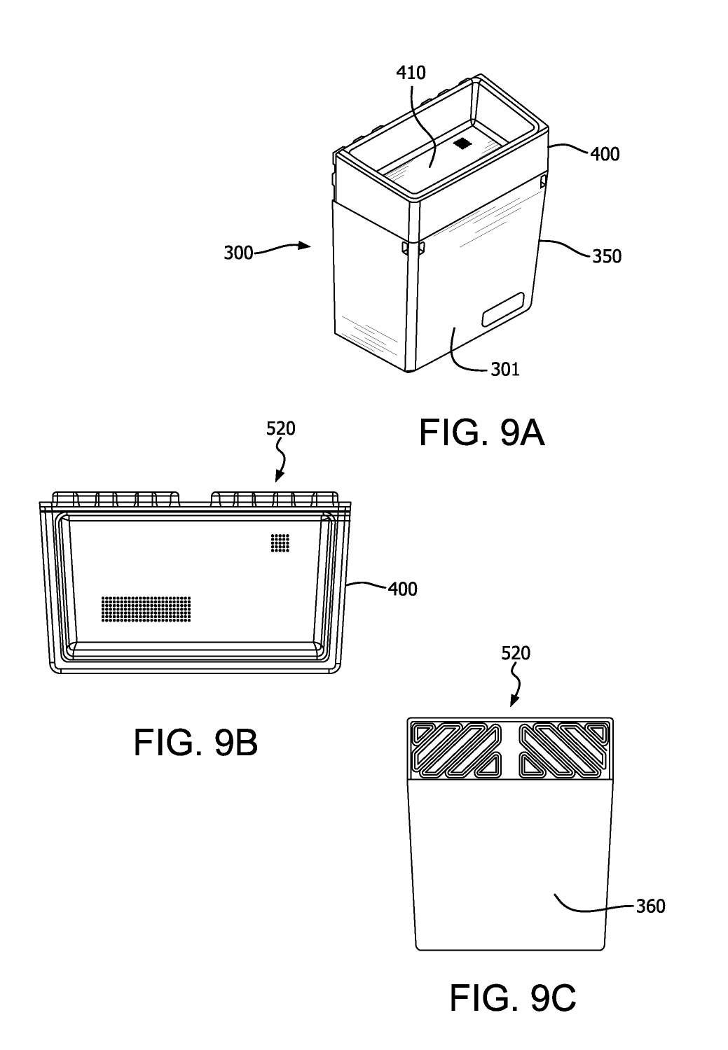

FIG. 8 is a perspective view of carbon dioxide generator cover housing 200 of the second embodiment of a bed bug monitor and/or capture device of this invention. In FIG. 8, hidden features are shown in phantom lines. Cover housing 200 is comprised of a bottom unit 210, a movable cover 220, a deadfall trap 230 and arm segments 240 and 241. The bottom unit has two dividers 211 and 212 which define three separate areas 214, 215 and 216. Areas 214, 215 and 216 can hold chemicals that when mixed together react to slowly release carbon dioxide. The bottom unit has channels 213 which form a lock and guide for the movable cover guides 223. A snap lock 222 is located above each cover guide to keep the movable cover 220 locked when in the closed position. To operate the carbon dioxide generation cover device the movable cover 220 is unlocked and lifted up. The cover housing 200 is turned over to allow the chemicals to flow from areas 214, 215 and 216 into the movable cover 220. The cover housing 200 is shaken to mix the chemicals and once the carbon dioxide generating chemicals are mixed, the movable cover 220 is left in the lifted position creating a head space chamber allowing the chemicals to react and generate carbon dioxide. The cover housing is hung on buttons 111 and 116 (shown in FIGS. 5 and 6) using arm segment 240 and 241. Carbon dioxide generated in the cover housing slowly rises in the head space and escapes the chamber through one or more slots 221 at the top of the movable cover 220.

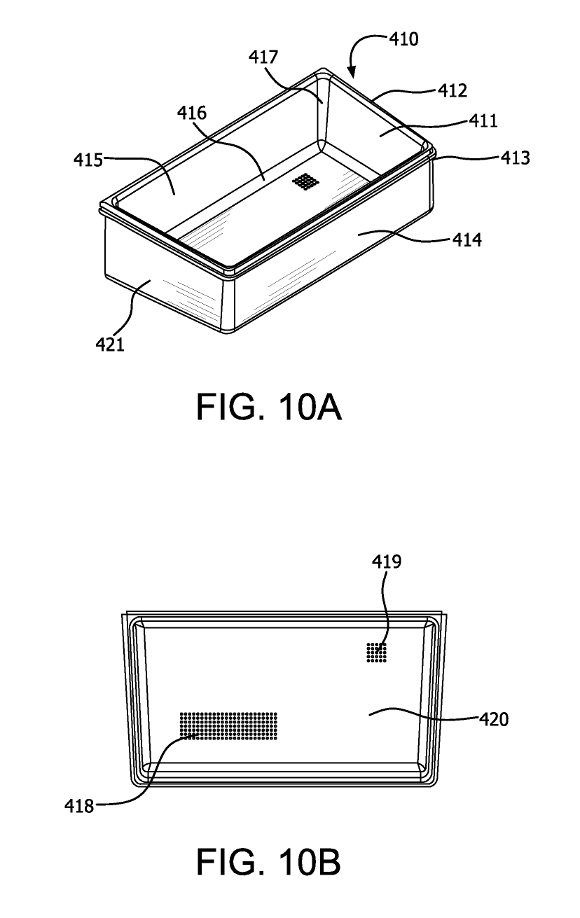

A third and further embodiment of a bed bug monitor and/or capture device 300 will be described with reference to FIGS. 9 through 17. Referring generally to those figures, the bed bug monitor and/or capture device 300 generally comprises a housing 301 defining a substantially enclosed interior space, a harborage 520 disposed on a rear panel 360 of the housing 301, an attaching means applied to the rear panel 360 of the housing 301 in order to attach the device 300 to a vertical surface, a kairomone/pheromone ampoule 490 coupled to an ampoule holder 470 that is mounted within the interior space of the housing 301, and a carbon dioxide generating cartridge 500 that is mounted within the interior space of the housing 301.

The housing 301 of the device 300 generally includes a holder insert 400, a bottom member holder 350 that at least partially encapsulates the holder insert 400, and a deadfall trap 410 that is positioned on the top surface of the holder insert 400. The holder insert 400, the bottom member holder 350 and the deadfall trap 410 can be separate components, or one or more of those components can be integrally formed together. Also, the harborage 520 can be an integral part of the housing 301 or can be a separate component that is mounted to the housing 301.

FIG. 9A is a top perspective view, FIG. 9B is a top view and FIG. 9C is a back view of the third embodiment of the bed bug monitor and/or capture device 300, which is shown in an assembled form. FIGS. 9A-9C depict the bottom member holder 350, the holder insert 400, the deadfall trap 410 and the harborage 520 of the device 300.

The deadfall trap 410 is positioned on the top side of the housing 301 of the device 300. The harborage 520 and the attaching means are both positioned on the rear panel 360 of the device 300. The attaching means is applied to the rear panel 360 in order to attach the device 300 to a vertical surface of a wall, for example. The harborage 520 will be positioned against the vertical surface to which the device 300 is attached because the attaching means and the harborage 520 are positioned on the same side of the device 300. Accordingly, a bed bug crawling up the vertical surface will encounter the harborage 520 of the device. The attaching means can be, for example, double sided tape, hooks and loops attachment means, glue, pins, string, elastic material or brackets and the like.

With the exception of the deadfall trap 410, the exterior facing surfaces of the housing 301 of the device 300 shown in FIGS. 9A-9C can have an average surface roughness of at least about 2.5 micrometers to provide a traversable surface for bed bugs.

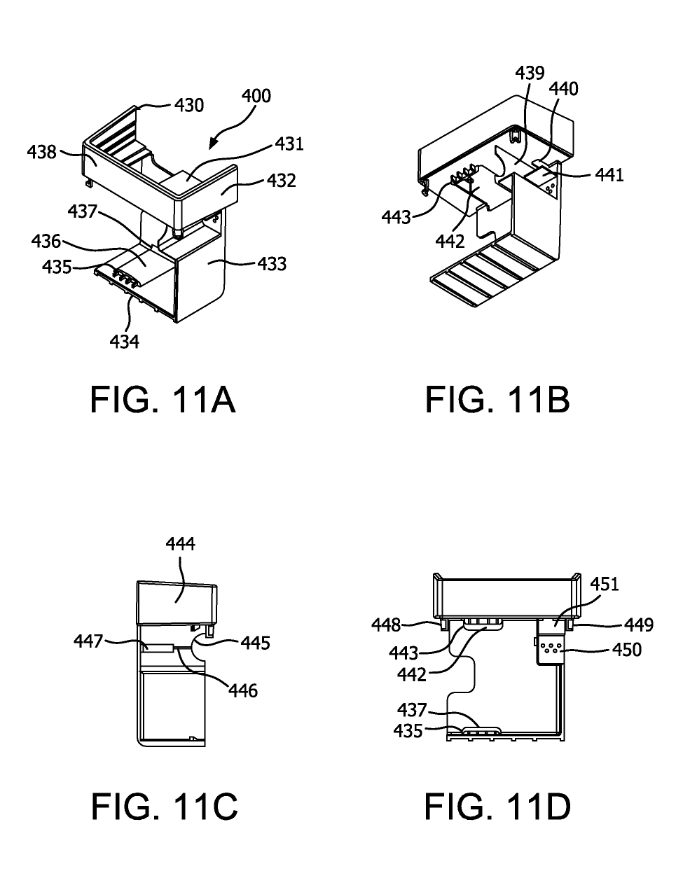

FIG. 10A is a perspective view and FIG. 10B is a top view of the deadfall trap 410, of the third embodiment of a bed bug monitor and/or capture device 300 of this invention. The deadfall trap 410 is composed of left side 411, front 414, right side 421, back side 415 and bottom 420. Although shown having four sides, the deadfall trap could also be a circular or oval configuration. The deadfall trap 410 includes a recessed region which is defined by a bottom surface 420 (bottom surface can be a generally flat, horizontal surface, or conical, or v-shaped, etc.) that is surrounded by one or more walls. The one or more walls can be vertical or sloped at an angle. The side surface or surfaces of the deadfall trap 410 are smooth so that any bed bugs that fall into the trap are not able to climb out. Preferably, the depth of the deadfall trap 410 is at least 1.7 cm in order to prevent bed bugs from escaping, more preferably at least 2 to 3 cm. The deadfall trap 410 can have a slope from back to front, for example, a 3% slope, or may have no slope at all. The joints 417 where the sides meet, and the joints 416 where the bottom meets the sides, are preferably rounded; however they can be 90 degree angles. The bottom surface 420 of the deadfall trap 410 has a plurality of openings 418 and 419 to allow carbon dioxide and kairomone(s) to enter the deadfall trap 410. Specifically, openings 418 allow carbon dioxide to enter the deadfall trap 410 and openings 419 allow kairomone(s) to enter deadfall trap 410. It should be understood that although a plurality of openings are shown in the figures, it may be possible to provide a single opening to allow each of carbon dioxide and kairomone(s) to enter the deadfall trap 410. It is desirable for the opening, or plurality of openings to be sufficiently small as to prevent bed bugs (and nymphs) from crawling out of the deadfall trap 410, yet sufficiently large to allow carbon dioxide and kairomone(s) to enter the deadfall trap 410.

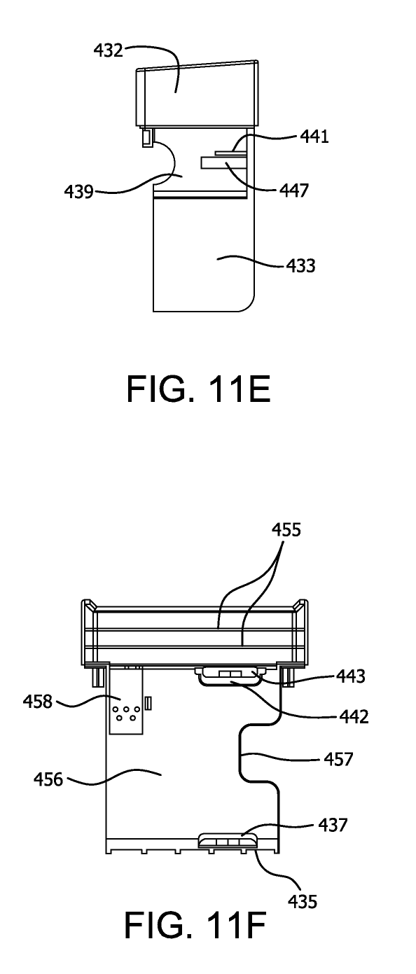

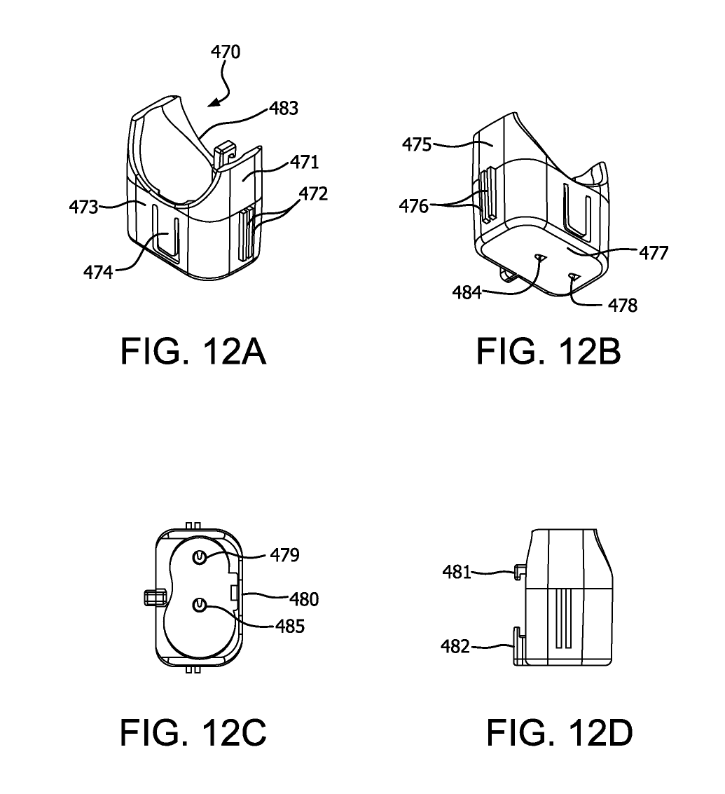

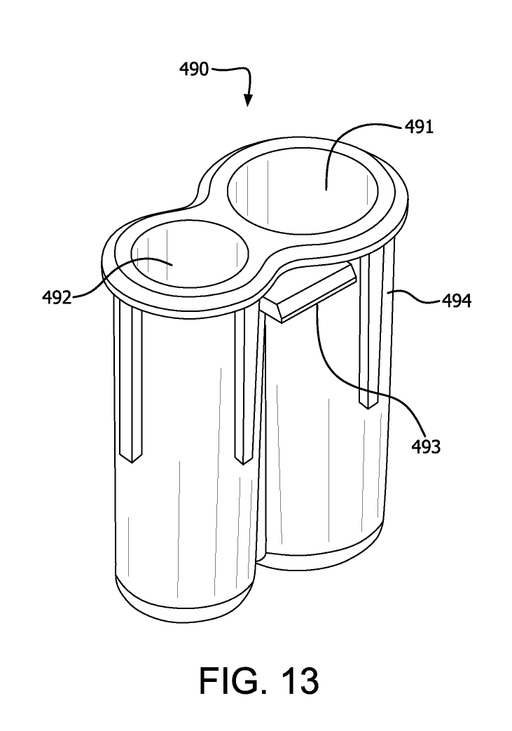

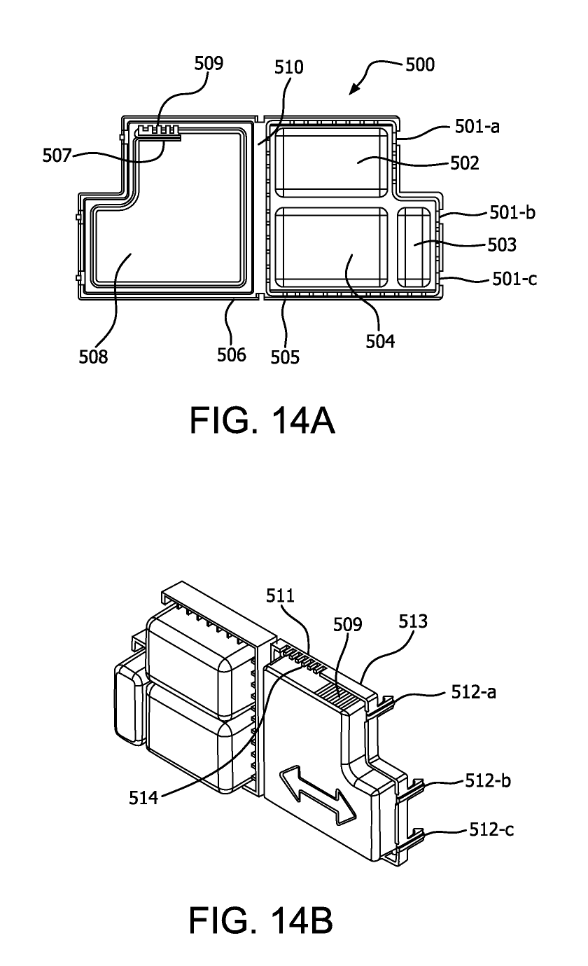

FIG. 11A is a top perspective view, FIG. 11B is a bottom perspective view, FIG. 11C is a left side view, FIG. 11D is a front view, FIG. 11E is a right side view and FIG. 11F is a rear view of holder insert 400 of housing 301 of the third embodiment of the bed bug monitor and/or capture device 300 of this invention. The holder insert 400 is designed to hold other elements of the bed bug monitor and/or trap which include the ampoule holder 470 of FIG. 12A, which in turn holds the pheromone/kairomone ampoule 490 of FIG. 13, the carbon dioxide cartridge 500 of FIG. 14A, the deadfall trap 410 and the harborage 520.

The holder insert 400 is comprised of two portions, i.e., a top portion to hold the harborage 520 and the deadfall trap 410, which is defined by a right side 432, a front 438, a left side 444 and a bottom 431, and a bottom portion, which is defined by lower right side panel 433, bottom 434 and back panel 456, designed to hold the carbon dioxide cartridge 500 and the ampoule holder 470. Although not shown, the deadfall trap 410 can be integrated with the top portion of the holder insert 400.

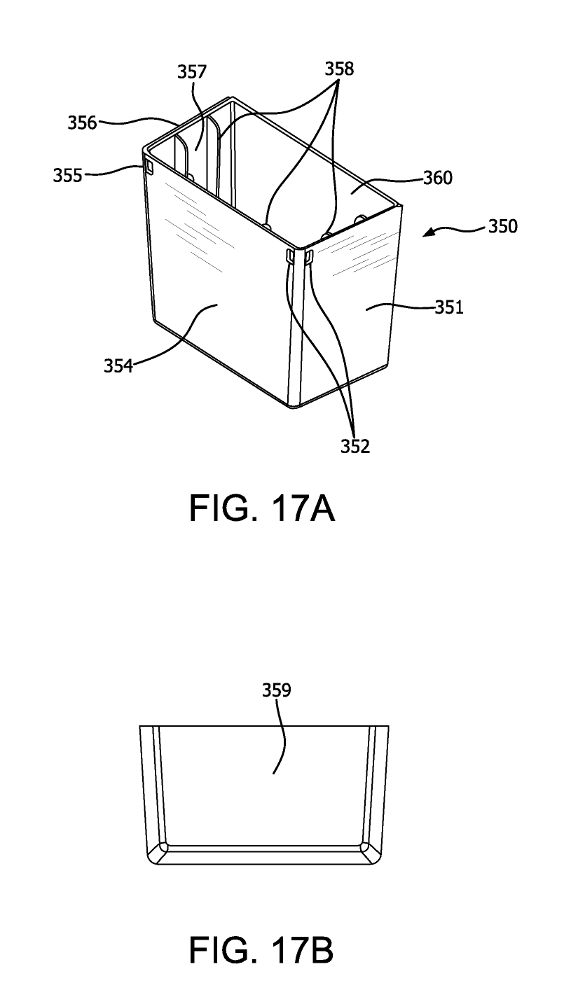

As best shown in FIG. 11C, the top edge of the top portion of the holder insert 400 can have a 3% slope from back to front, for example, or may have no slope at all. The bottom 431 of the top portion of the holder insert 400 has at least one opening 442, which allows carbon dioxide generated in the carbon dioxide cartridge 500 of FIG. 14A to enter the deadfall trap through openings 418 of the deadfall trap 410 and also allows moisture in the air to enter carbon dioxide generating cartridge 500. In this regard it may be desirable to have moisture present in the cartridge to drive the reaction creating the carbon dioxide. The opening 442 can extend to the back panel 456. The underside of bottom 431 has a guide (top guide 443) to aide in guiding and holding the top of the carbon dioxide cartridge 500. The underside of bottom 431 also can contain tabs 448 and 449 which align with holes 352 and 355 of the holder 350 (see FIG. 17A) forming a means of locking holder insert 400 with holder 350.

The lower right side panel 433 is designed to have the upper part of the panel indented, as indicated by upper part 439, to accommodate the ampoule holder 470 of FIG. 12A. Horizontal panel 441 protrudes from back panel 456 in a forward direction to form a divided compartment once the ampoule holder 470 is in place.

The kairomone fumes emanating from the vial 492 (see FIG. 13) are directed through a discrete pathway of the device 300 to the deadfall trap 410. More particularly, once the ampoule holder 470 is in place, space 451 directs the kairomone fumes produced by the vial 492 (see FIG. 13) into the deadfall trap 410 through a hole 440 located in bottom 431, and to the plurality of openings 419 in the deadfall trap 410.

The pheromone fumes emanating from the vial 491 (see FIG. 13) are directed through a discrete pathway of the device 300 to the harborage 520. More particularly, one or more openings 450 are located on the inside of the back panel 456. In use, pheromone fumes produced by vial 491 (see FIG. 13) are directed through the openings 450 and upwards into the harborage 520.

An indentation 445 on the side wall 433 of the holder insert 400 provides room for a person's finger in order to insert and remove the kairomone/pheromone ampoule 490 from the ampoule holder 470.

Raised portion 446 on the side wall 433 of the holder insert 400 provides an attachment point for ampoule holder clip 481 (see FIG. 12D), and hole 447 on the side wall 433 provides an attachment point for ampoule holder clip 482 (see FIG. 12D) to attach the ampoule holder 470 to the holder insert 400.

The bottom 434 of the holder insert 400 comprises a bottom guide and holder 435, to aide in guiding and holding the bottom of the carbon dioxide cartridge 500. Bottom 434 also has an indented space 436 which allows carbon dioxide to enter the inside of holder 350 through a hole 437 located through the back panel 456.

FIG. 11E is a right side view of the holder insert 400 showing right side 432, lower right side 433, indented upper part 439, horizontal panel 441 and hole 447. FIG. 11F is a rear view of holder insert 400 showing the back panel 456 designed with indentation 457 to provide room for a person's finger in order to insert and remove the carbon dioxide cartridge 500, holes 442 and 437, upper guide 443, lower guide 435, channel 458 and support and guide ribs 455 located on the inside portions of right side panel 432, front 438 and left side panel 444.

FIG. 12A is a top perspective view, FIG. 12B is a bottom perspective view, FIG. 12C is a top view and FIG. 12D is a left side view of an ampoule holder 470 of the third embodiment of the bed bug monitor and/or capture device 300 of this invention. The ampoule holder 470 comprises a right side 471, a front 473, a left side 475, a back 483 and a bottom 477 and is open on the top. Sides 471 and 475 have protruding guides 472 and 476 that aide in guiding and holding the ampoule holder 470 when attached to panel 439 of holder insert 400 with clip 481 attaching to raised portion 446 and clip 482 attaching through hole 447. Front 473 contains an interlock 474 having a tang 480, protruding inward to connect with tab 493 of ampoule 490. Although not shown, the ampoule holder can be integrally formed with the holder insert 400 of the housing 301.

Preferably, the inside of the ampoule holder 470 is designed to hold an ampoule 490 (see FIG. 13) having two integrated vials of differing size as can be seen from the top view FIG. 12C. Two tapered needles 479 and 485 having a hollow groove, can protrude about 3 to 4 mm from the inside of bottom 477 and are positioned in such a manner that when ampoule 490 is inserted into holder 470, the needles 479 and 485 puncture the sealing material covering the ampoule openings entering the headspace of each vial of the ampoule 490 allowing the volatilized kairomone and pheromone to pass through the hollow grooves of the needles 479 and 485 and then through holes 478 and 484 into spaces 451 and 450, respectively, of the holder insert 400.

FIG. 13 is a perspective view of ampoule 490 of the third embodiment of the bed bug monitor and/or capture device 300 of this invention. Ampoule 490 comprises two integrated vials which can have the same or different capacities. Preferably, vial 491 is slightly larger than vial 492. This prevents the end user from improperly inserting the ampoule 490 into ampoule holder 470 (discussed further below). Vial 491 is designed to hold a pheromone solution, for example, Octenal and/or Hexenal dissolved in nonane.

Vial 492 is designed to hold a kairomone solution, for example, butyric acid dissolved in nonane. Tab 493 is positioned near the top of the ampoule 490 so as to engage tang 480 of the ampoule holder 470 when ampoule 490 is fully inserted into ampoule holder 470. By virtue of the shape of the vials of the ampoule 490, the interior shape of the ampoule holder 470, and the arrangement of the tang 480 and the tab 493, the ampoule 490 may only be inserted into the ampoule holder 470 in a single orientation.

Once filled with the proper solutions, the openings of vial 491 and 492 are sealed with a material that can be punctured by needles 479 and 485. The sealing material is preferably metal foil or plastic film. Alternatively, separate vials having a seal that can be punctured can be inserted into vials 491 and 492. Ribs 494 help guide and stabilize the ampoule 490 once inserted into ampoule holder 470.

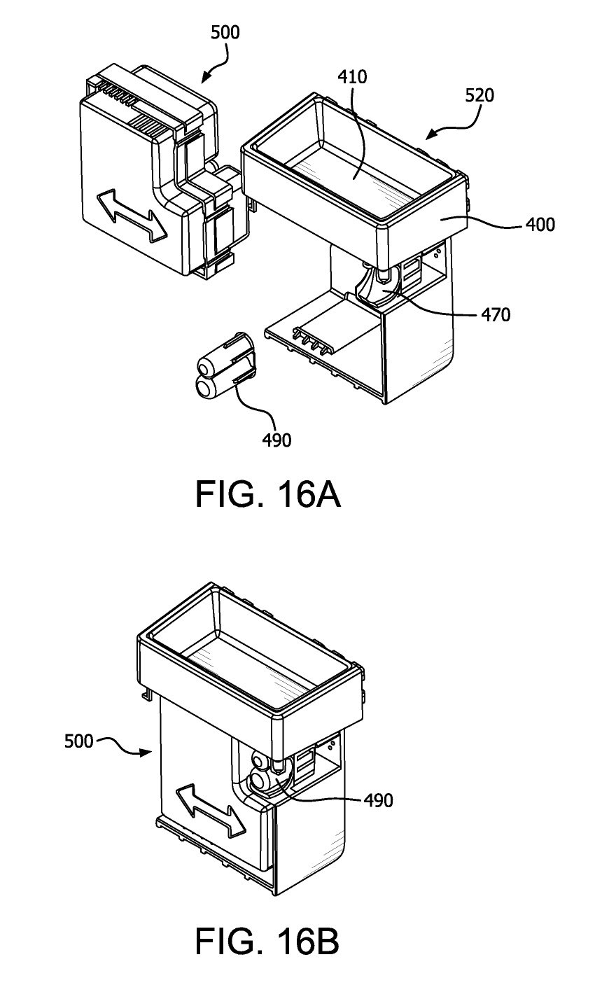

FIG. 14A is a front view and FIG. 14B is a top perspective view of the rear of the carbon dioxide generating cartridge 500, of the third embodiment of a bed bug monitor and/or capture device 300 of this invention. The carbon dioxide generating cartridge 500 includes a clam-shell style housing including two housing portions that are integrally and pivotably connected together by a living hinge 510. The cartridge 500 is shown in an open configuration in FIGS. 14A and 14B, whereas the cartridge 500 is shown in a closed configuration in FIG. 16A.

The first housing portion of the cartridge 500 contains three compartments 502, 503 and 504 for the chemicals needed to generate carbon dioxide. Compartment 502 can contain a dry or solid acid such as citric acid. An anti-clumping agent, such as fumed silica, for example, Cab-O—Sil® fumed silica from Cabot Corporation, kaolin clay, amorphous silica, for example, Siloid® silica from W.R. Grace and Company, or mixtures thereof, can be added to the dry acid in the compartment 502 to maintain a free flowing dry material while in storage. Compartment 503 can contain a dry deliquescent material such as magnesium chloride, or water or a source of water that is capable of releasing the water once the contents of each compartment are mixed together. Compartment 504 can contain a solid basic material such as sodium bicarbonate. Once filled with the proper amounts of dry reagents, compartments 502, 503 and 504 are preferably sealed with a material that can be punctured or removed to allow the dry reagents to be released from each compartment prior to mixing. The sealing material can be, for example, foil or plastic. Compartment 502, 503, and/or 504 can contain a hard or sharp material, such as ball bearings, to break up any clumps formed prior to use to aid in mixing.

The second housing portion of the cartridge 500 includes a compartment 508 that provides room for mixing the dry reagents once the cartridge 500 is closed.

To use the carbon dioxide generating cartridge 500, the user either peels off the foil or plastic that seals the dry reagents in compartments 502, 503 and 504 or punctures the seal sufficiently to allow the dry reagents to exit the compartments. The user closes the cartridge 500 and seals it by locking tabs 512-a, 512-b and 512-c of the second housing portion onto catches 501-a, 501-b and 501-c of the first housing portion, respectively. Rim 506 of the second housing portion fits into slot 505 of the first housing portion once the cartridge 500 is closed, thereby sealing the cartridge 500.

Baffle 507 aids in the prevention of dry reagents escaping the compartment 508 while the user shakes the closed cartridge 500 until the reagents are mixed. Once the chemicals are mixed, the user inserts cartridge 500 into the holder insert 400 and the carbon dioxide generated escapes the cartridge 500 through a defined pathway in the device 300 to the deadfall trap 410. More particularly, the carbon dioxide passes through a plurality of vents 509 in the cartridge 500, travels through the space 514 defined by the outer edge of compartment 508 and rim 513 (surrounding compartment 508), travels through vents 511 located in the outer rim 513 and enters the holes 418 in the deadfall trap 410. Vents 511 are designed to be located below holes 418 in the deadfall trap 410.

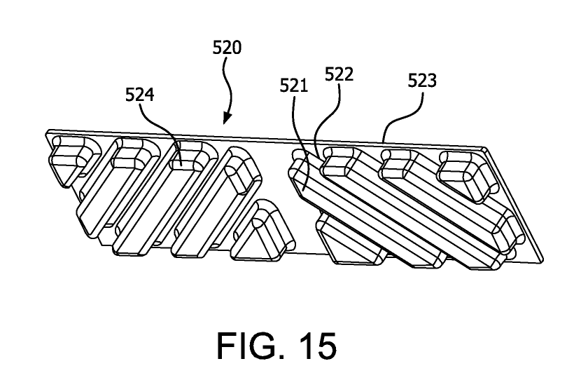

FIG. 15 is a perspective view of harborage 520, of the third embodiment of the bed bug monitor and/or capture device 300 of this invention. It has been discovered that bed bugs are attracted to the harborage 520 due to its material composition, surface roughness and/or shape. In this embodiment, the harborage 520 includes a base segment(s) 521 being adapted to be placed flush with the vertical surface against which such device 300 is to be placed; an interior segment 522, which defines at least one entrance through which bed bugs attracted to the device 300 can enter; and a back segment 523, designed to be attached to the back 415 of the deadfall trap 410. Alternatively, the harborage 520 can cover all or most of the entire outer surface of the housing 301 of the device 300. Additionally, the harborage 520 can be integrated with the rear panel 360 of the housing 301, or the harborage 520 can be a separate component, as shown.

The interior segment 522 of the harborage 520 provides at least one entrance through which bed bugs can enter. One or more protuberances 524 depend outward from the inner surface of the back segment 523. The one or more protuberances 524 define one or more channels or pathways which are of sufficient dimensions to permit a bed bug to crawl therein. Preferably, such protuberances 524 are spaced to form channels or pathways having a width of between about 2 mm and about 10 mm. The protuberances 524 are preferably designed such that bottom portion of the channels formed thereby are concave in cross section. The protuberances 524 should be of sufficient height such that bed bugs can crawl through the channels formed thereby. A width dimension of the channels or pathways formed between adjacent protuberances 524 can progressively decrease in a direction toward the deadfall trap 410 to attract bed bugs toward the deadfall trap 410.

The inner surface of the protuberances 524 is preferably comprised of a material that provides a traversable surface for bed bugs, such that the average surface roughness of such surface is at least about 2.5 micrometers. The protuberances 524 are preferably angled from the center of the back segment 523 in a downwardly facing direction. Although not shown, a sheet of material can be mounted over the protuberances 524, thereby defining substantially enclosed channels in the harborage 520. Such a sheet material preferably would be clear to allow for easy visual inspection of the harborage 520.

FIG. 16A is an exploded, top perspective view of a partial assembly of the device 300 including the following components: holder insert 400, deadfall trap 410, ampoule holder 470, harborage 520, carbon dioxide cartridge 500 and ampoule 490. FIG. 16B is a top perspective view of the partial assembly of FIG. 16A shown assembled.

FIG. 17A is a top perspective view of the holder 350 of the housing 301 and FIG. 17B is a bottom view of the holder 350. Holder 350 comprises right side panel 351, front panel 354, left panel 357, rear panel 360 and bottom 359. The holder 350 substantially encloses the interior of the housing 301. The top of holder 350 is open in order to receive holder insert 400. Holes 352 and 355 are located at the top corner of right side panel 351 and front panel 354 and at the top corner of front panel 354 and left panel 357, respectively, in such a position as to be engaged by tabs 449 and 448, respectively, when holder insert 400 is placed into holder 350. Moreover, further means can be used to secure holder insert 400 with holder 350. For example, zip ties, wires, string, twist ties, or other suitable securing means can be inserted through holes 352 and 355 and secured to tabs 449 and 448 to further secure together holder insert 400 and holder 350. Support ribs 358 guide and support holder insert 400 when said insert 400 is placed into holder 350. Preferably, the outer surfaces of holder 350 provide a traversable surface for bed bugs, such that the average surface roughness of such surface is at least about 2.5 micrometers. The holder 350 and holder insert 400 are designed so that the attaching means (e.g., double sided tape, hooks and loops, glue, pins, string, elastic material, brackets, or the like) placed on rear panel 360 and the base segment(s) 521 are flush with the vertical surface against which such device 300 is to be placed. Moreover, suitable attaching means can be provided to bottom 359 to provide a means for attaching the device to a horizontal surface. Furthermore, both rear panel 360 and bottom 359 can be provided with suitable attaching means.

It is well known in the art that certain chemical reactions can generate carbon dioxide. For the purpose of the present invention it is desirable to generate carbon dioxide for a prolonged period of time. It is preferred that carbon dioxide be generated for a period of about 36 hours. A chemical reaction between an aqueous acid and sodium bicarbonate generates carbon dioxide; however the reaction is usually quick. The inventors have found that by mixing a dry acid, for example, citric acid monohydrate and dry sodium bicarbonate, the deliquescent anhydrous citric acid absorbs moisture from the air sufficiently to evolve carbon dioxide slowly over one to three days. This reaction can be accelerated by adding a deliquescent chemical such as magnesium chloride. Moisture from the air is absorbed by the citric acid and magnesium chloride accelerating the generation of carbon dioxide. By adjusting the ratios of citric acid, sodium bicarbonate and magnesium chloride, the generation of carbon dioxide can be regulated.

### EXAMPLES

### Example 1

Into a room controlled at 50% humidity and about 70° F., was placed a plastic children's pool (POLY POOL by General Foam Plastics Corporation, Norfolk Va.) which was lined with brown kraft paper to provide a suitable walking surface for bed bugs, using masking tape to hold the paper in place. Twenty five bed bugs were placed into a paper cup that contained a four inch by four inch piece of flannel cloth as a harborage. The cup was capped, pin holes in the cap provided air for the bed bugs, and held for two hours, then was placed in the pool and allowed to acclimate. After about three hours the flannel harborage was transferred from the paper cup into the pool, about ten inches from the side.

A bed bug monitor and/or capture devise was prepared by cutting two 4 inch by 4 inch pieces of chipboard and one 4 inch by 4 inch piece of fluted cardboard. The fluted cardboard was sandwiched between the chipboards and the unit was stapled on two sides to hold the unit together, creating a base segment (first piece of chipboard) an interior segment (fluted cardboard) and a top segment (second piece of chipboard). Two 50 mL plastic centrifuge tubes (Corning® 50 mL polypropylene centrifuge tubes) were taped to the top segment chipboard, with the fluting running vertical.

An ampoule was constructed employing a cylindrical outer shell made of polyethylene, and having a height of 14.5 mm and a diameter of 11 mm. These outer shells were filled with a solution containing 2.535 milligrams of Octenal in 300 microliters of nonane. A cylindrical porous diffusion member, made of ultra high molecular weight polyethylene, was disposed inside the outer shell in a contraposition such that the volatile liquid was contained in the interior reservoir formed by such diffusion member. The opening of the outer shell was then thermally sealed with an aluminum film member, leaving a head space of about 2-2.5 mm between the bottom portion of the diffusion member and the top of the diffusion member. A hole having a diameter of about 0.23 mm was made in the aluminum film by puncturing it with a needle. A second vial containing 71.85 micrograms of butyric acid in 300 microliters of nonane was prepared in a similar manner as described above. The vials containing attractants Ocetenal and butyric acid were taped to the top of the device in a horizontal manner.

A mixture of 13.5 grams of citric acid monohydrate, 16.5 grams of sodium bicarbonate and 2.0 grams of magnesium chloride was placed into a separate container, the container was capped and the contents shaken until a homogenous mixture was obtained. The chemical mixture was divided equally between the two 50 mL plastic centrifuge tubes.

The bed bug monitor and/or capture device was attached to the back side of a “L” shaped wooden stand using plastic push pins. The wooden stand was made by vertically attaching a 10 inch by 10 inch piece of pine lumber to a base piece of 10 inch by two and a half inch piece of pine lumber. The back surface of the 10 inch by 10 inch vertical “L” shaped frame was roughened employing 100 grit sandpaper. The “L” shaped frame with the attractants affixed was placed in the children's pool about 24 inches from the flannel harborage. A weight was placed on the base piece to prevent the “L” shaped frame from tipping over. After 17 to 18 hours the device was removed and the number of bed bugs in the device, including those that fell into the open 50 mL centrifuge tubes, were counted. The test was repeated several times. Control tests using devices containing no attractants (bed bugs were released from inverted Petri dish cover after acclimation period) and tests using devices that contained only Octenal and butyric acid were also tested in the same manner as described above. The average number of bed bugs found in the devices is summarized in Table 1 below.

TABLE 1
Bed Bugs Caught In Vertical Test Devices

| | Octenal and | | |
|---|---|---|---|
| Number of | Butyric Acid | Carbon Dioxide | Average % Bed Bugs |
| Replicates | Attractant Used | Used | Found in Device |
| 7 | None | None | 17 |
| 5 | Yes | None | 20 |
| 12 | Yes | Yes | 38 |

What is claimed is:

1. A bed bug monitor and/or capture device comprising:
a housing defining a substantially enclosed interior space;
at least one bed bug attractant element positioned within the interior space of the housing;
a harborage element that is either defined on the housing or positioned on the housing, said harborage element defining at least one pathway through which bed bugs can travel; and
at least one opening defined in at least one wall of the housing at a location adjacent the harborage element, wherein fumes emanating from the bed bug attractant element can escape through the at least one opening to a location outside of the device in order to attract bed bugs toward said harborage element.

2. The device of claim 1, wherein the housing comprises a deadfall trap that is positioned adjacent the harborage element, wherein at least one opening of the housing and/or an opening in the deadfall trap are located such that fumes emanating from the bed bug attractant element attract bed bugs toward said deadfall trap.

3. The device of claim 2, wherein the deadfall trap includes a flat recessed area that is surrounded by at least one wall to either limit or prevent escapement of bed bugs from the deadfall trap once inside the deadfall trap.

4. The device of claim 2, wherein a width dimension of the at least one pathway of the harborage element decreases in a direction toward said deadfall trap to attract bed bugs toward said deadfall trap.

5. The device of claim 2, wherein the deadfall trap is disposed on a top surface of the housing and the harborage element is disposed on a side surface of the housing.

6. The device of claim 1, wherein the bed bug attractant element comprises a source of aldehyde, a source of organic acid and a source of carbon dioxide.

7. The device of claim 6, wherein a first opening defined in at least one wall of the housing is positioned to pass fumes emanating from the source of aldehyde, a second opening defined in at least one wall of the housing is positioned to pass fumes emanating from the source of organic acid, and a third opening defined in at least one wall of the housing is positioned to pass fumes emanating from the source of carbon dioxide.

8. The device of claim 7, wherein the housing includes a deadfall trap that is positioned adjacent the harborage element, wherein the first opening is provided on a side wall of the housing adjacent the harborage element, and the second and third openings are provided in the deadfall trap of the housing.

9. A bed bug monitor and/or capture device comprising:
a housing defining a substantially enclosed interior space and a deadfall trap;
at least one bed bug attractant element positioned within the interior space of the housing; and
at least one opening defined in at least one wall of the housing at a location either on or adjacent the deadfall trap, wherein fumes emanating from the bed bug attractant element can escape through the at least one opening to a location outside of the device in order to lure bed bugs toward said deadfall trap.

10. The device of claim 9, wherein the deadfall trap includes a flat recessed area that is surrounded by at least one wall to either limit or prevent escapement of bed bugs from the deadfall trap once inside the deadfall trap.

11. The device of claim 9 further comprising a harborage element disposed on the housing that defines at least one pathway through which bed bugs can travel.

12. The device of claim 11, wherein the deadfall trap is disposed on a top surface of the housing and the harborage element is disposed on a side surface of the housing.

13. The device of claim 9, wherein the bed bug attractant element comprises a source of aldehyde, a source of organic acid and a source of carbon dioxide.

14. The device of claim 13, wherein a first opening defined in at least one wall of the housing is positioned to pass fumes emanating from the source of aldehyde, a second opening defined in at least one wall of the housing is positioned to pass fumes emanating from the source of organic acid, and a third opening defined in at least one wall of the housing is positioned to pass fumes emanating from the source of carbon dioxide.

15. The device of claim 14, further comprising a harborage element disposed on the housing adjacent the deadfall trap, wherein the first opening is provided on a side wall of the housing adjacent the harborage element, and the second and third openings are provided in the deadfall trap of the housing.

16. The device of claim 14, further comprising a harborage element disposed on the housing adjacent the deadfall trap, said harborage element being located on a side surface of the housing and the deadfall trap being located on a top surface of the housing.

17. A kit for monitoring and/or capturing bed bugs comprising:
a housing defining a substantially enclosed interior space and a plurality of apertures defined in one or more walls of the housing that provide one or more fume passageways leading from the interior space to one or more locations outside of the housing to attract bed bugs toward the housing;
a source of carbon dioxide that is configured to be positioned within the interior space of the housing at a location that is adjacent at least one of the plurality of apertures of the housing;
a source of organic acid that is configured to be positioned within the interior space of the housing at a location that is adjacent at least one of the plurality of apertures of the housing; and
a source of aldehyde that is configured to be positioned within the interior space of the housing at a location that is adjacent at least one of the plurality of apertures of the housing.

18. The kit of claim 17, wherein the sources of carbon dioxide, organic acid and aldehyde are each sealed to prevent inadvertent escapement.

19. A carbon dioxide cartridge assembly for a bed bug monitor and/or capture device comprising:
a housing including a substantially enclosed interior space having a plurality of internal compartments, and at least one opening defined in a wall of the housing to permit the escapement of carbon dioxide from within the interior space to a location outside of the housing to attract bed bugs towards the bed bug monitor and/or capture device;
a first chemical composition contained within a first compartment of the plurality of compartments;
a second chemical composition contained within a second compartment of the plurality of compartments; and
a third chemical composition contained within a third compartment of the plurality of compartments;
one or more removable seals covering the first, second and third compartments to prevent inadvertent mixing of the chemical contents within the plurality of compartments, wherein upon removing the seals, the chemical contents within the plurality of compartments can be mixed together to produce carbon dioxide.

20. The carbon dioxide cartridge assembly of claim 19 further comprising an anti-clumping agent contained within one of the compartments.

21. The carbon dioxide cartridge assembly of claim 19, wherein each chemical composition is selected from the group consisting of dry acid, solid basic material, and dry deliquescent material.

22. An ampoule assembly for a bed bug monitor and/or capture device comprising:
a housing including two discrete vials;
a first chemical composition contained within one vial of the housing;
a second chemical composition contained within the other vial of the housing; and
one or more seals covering the vials to prevent inadvertent escapement of the chemical contents of the vials.

23. The ampoule assembly of claim 22 further comprising an ampoule holder to which the housing is releasably mounted.

24. The ampoule assembly of claim 23, wherein the ampoule holder includes two needles that are configured to puncture the one or more seals covering the vials of the housing upon mounting the housing to the ampoule holder.

25. The ampoule assembly of claim 23, wherein the housing is configured to be mounted to the ampoule holder in only a single orientation.

26. A bed bug deadfall trap having one or more openings through a surface thereof.

27. The bed bug deadfall trap of claim 26, further comprising a harborage mounted adjacent to the deadfall trap.
